(19) United States
(12) Patent Application Publication
(10) Pub. No.: US 2008/0256567 A1
(43) Pub. Date: Oct. 16, 2008

(54) SYSTEM AND METHOD FOR PROVIDING PACKAGED PROGRAMMING TO ELECTRONIC MEDIA PLAYERS

(76) Inventor: Christopher Butler, Wayland, MA (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 12/101,567

(22) Filed: Apr. 11, 2008

Related U.S. Application Data
(60) Provisional application No. 60/907,714, filed on Apr. 13, 2007.

(51) Int. Cl. H04N 7/173

(52) U.S. Cl. 725/2

(57) ABSTRACT

The present invention relates to providing packaged programming for use on electronic media players. In particular the present invention relates to providing entertainment programming packaged together with advertising, in downloadable form, for use on electronic media players. The service may be supported by subscription fees, by advertising fees, are a combination thereof. The service provider, in turn, uses a portion of the moneys generated for operating expenses and profit, as well as to pay pre-negotiated royalty fees to the copyright owners of the aforementioned programming.

### CROSS-REFERENCE TO RELATED APPLICATIONS

This application claims priority under 35 U.S.C. § 119(e) from U.S. Provisional Application Ser. No. 60/907,7145 entitled “System and Method For Providing Packaged Programming to Electronic Media Players,” filed Apr. 13, 2007, which is hereby incorporated herein by reference in its entirety.

### TECHNICAL FIELD

The present invention relates to providing packaged programming located on remote servers for use on electronic media players. In particular, some embodiments of the present invention relate to providing entertainment programming packaged together with advertising, in downloadable form, for use on electronic media players.

### DESCRIPTION OF THE RELATED ART

The advent and subsequent development of the internet has created new avenues or the distribution of data. One can download music, movies, television programming, even software directly to one's computer or electronic media player. This allows for businesses, from software companies to the music industry, to sell their products directly to the public in electronic form. This saves time, packaging, handling, shipping costs, etc. for both the seller and the consumer. This also allows consumers to buy a variety of products instantly, 24 hours a day.

While the advantages of the internet are obvious, there are some obvious pitfalls as well. A combination of factors, including the proliferation of peer-to-peer file transfer systems and direct file sharing sites, to name but a few, allow the transfer of a variety of electronic media from one user's computer to another with virtual anonymity. Because of the way these types of programs operate, tracking of these uploads and downloads is very difficult. Therefore, these types of programs provide free, unlicensed access to music, video, and other copyrighted media with little opportunity for enforcement against their proprietors.

The loss of royalty revenues for both the entertainment industry and artists has been significant. The Canadian Record Industry Association (CRIA) embodiments revenue losses of approximately $100 million annually due to file-sharing. Since 1998, retail sales of CD and cassette recordings in Canada have decreased by almost 30%. In the United States, the Recording Industry Association of America (RIAA) blames file-sharing for a decrease in CD sales from $13.2 billion in 2000 to $11.2 billion in 2003.

The present systems and methods of the present invention address many of the issues that have led to this current imbalance in the entertainment industry. The present systems and methods provide a convenient outlet for users to download music and entertainment in packaged form. Users download the music but only, in a specific embodiment, have the right to use the music and cannot, for instance, duplicate it. However, rather than having to go to a service and pay for songs or albums individually,

users are provided with a package of music and advertising (if appropriate) that has been pre-assembled according to, in one embodiment, individual preferences. The subscriber merely has to synchronize (“synch”) their electronic media device to receive a fresh package on a periodic or ad hoc basis and specifically, in one embodiment of the invention, on a daily basis (or less frequently if they choose). This synchronization may be manual or automatic.

In one embodiment, this package may be totally or partially supported by user subscription rates and may be, in one embodiment, free from advertisements. Alternatively, the package may contain both entertainment programming and advertisements. This embodiment would allow the service to be partially or totally supported by advertising revenue. Revenues, collected through subscription fees, advertising fees, or a combination thereof, may then be used to pay operating expenses and profits for the service provider. Finally, a portion of the revenue, in one embodiment, may used to pay royalties to the owner of the copyrighted programming used in the system.

### BRIEF SUMMARY OF EMBODIMENTS OF THE INVENTION

The system of the present invention, in one embodiment, comprises a system on a remote server for providing entertainment programming packaged with advertisements, in downloadable form to subscribers for use on subscriber's electronic media player. The entertainment programming can be music, video, talk, sports, information, education and, or news programming. In one embodiment, the subscribers pay for a subscription to use the system. In another embodiment the subscription is entirely paid by advertising and there is no charge or a reduced or minimal charge to the subscriber. Alternatively, the subscribers may pay for a portion of the subscription and advertising or other fees pay for a portion of the subscription. The subscription may also be paid on a per use, daily, weekly, monthly, yearly, multiple year, or one-time fee basis.

The electronic media players used in the system can be any portable device such as, for example, MP3 players, cell phones, Personal Digital Assistants, or personal computers. Additionally, the MP3 players may comprise one or more selected from the group consisting of Apple iPod or iPhone, Creative Labs Zen Vision, Toshiba Gigabeat, iRiver Clix, Microsoft Zune or Samsung YP-K3. In addition, the cell phones may comprise one or more selected from the group consisting of T-Mobile Sidekick, Samsung SGH-T809, Motorola Razr V3m, Sony Ericsson W810i, and LG LX550 Fusic. Finally, the Personal Digital Assistants may comprise one or more selected from the group consisting of Hewlett Packard iPAQ rx5915, Palm Tungsten E2, Palm Z22, Dell Axim X51v, Sony Clie PEG-NX60 or TG50, Handspring Visor Platinum, and Handspring Treo 180.

In one embodiment, a method of the present invention comprises the steps of registering with a remote server and receiving an electronic key, downloading proprietary software, extracting the key with the software, subscribing to one or a number of entertainment programming and specifically, in one embodiment, music programs and performing an initial synchronization of registrant's electronic media player.

Examples of electronic media players include portable music player players, cell phones, portable gaming devices, Personal Digital Assistants (PDA), or personal computers and laptops. Examples of MP3 or portable music players include Apple iPod Creative Labs Zen Vision, Toshiba Gigabeat, iRiver Clix, Samsung YP-K3, and Microsoft Zune. Examples of cell phones are T-Mobile Sidekick, Samsung SGH-T809, Motorola Razr V3m, Sony Ericsson W810i, and LG LX550 Fusic. Examples of PDAs include Hewlett Packard iPAQ rx1955, Palm Tungsten E2, Dell Axim X51v, Sony Clie PEG-NX60, and Handspring Visor Platinum. Examples of portable gaming devices include Sony PSP and Nintendo DS.

In a further embodiment, the method includes the steps of erasing any current programs from the subscriber's electronic media player connected to a subscriber's computer with proprietary software; downloading encrypted data from a remote server to the proprietary software; applying subscriber's key with the proprietary software; exporting the program into subscriber's data management program with the proprietary software; approving subscriber's key with the data management program, accepting the new program by the data management program; and uploading the new program to subscriber's electronic media player with the data management program.

In yet another embodiment, the subscriber's data management program may comprise one or more media applications such as, but not limited to, iTunes, Windows Media Player, Real Player, Windows Explorer, or Creative Media Explorer. The subscriber's electronic media player may also be connected to subscriber's computer using wired or wireless interface such as, but not limited to, a USB interface, Bluetooth interface infrared, Firewire, i.Link, or IEEE 1394 connection (also referred to as FireWire).

In yet another embodiment, the method of the present invention comprises the steps of: synchronizing a subscriber's electronic media player with the subscriber's data management program, downloading usage statistics from the electronic media player to the data management program; transferring the usage statistics from the data management system to the proprietary software; and uploading subscriber usage statistics to supplier's server from the proprietary software.

The methods of the present invention further comprises the steps of: uploading usage statistics from proprietary software located on each subscriber's computer; compiling the usage statistics from all subscribers for a given billing period; and billing advertisers based on the compiled usage statistics. The invention also includes a method comprising the steps of: uploading usage statistics from proprietary software located on the subscriber's computer; compiling the usage statistics from all subscribers for a given billing period; and paying royalties to the copyright owners based on the usage statistics.

In one embodiment of the present invention, a system for delivering entertainment programming is provided that comprises: a server having a plurality of entertainment and advertisement programs; a media delivery module configured to package a programming package having embedded advertisements, wherein the programming package contains entertainment programs from the server; ad a media player in communication with the delivery module configured to receive and play the entertainment programming package with embedded advertisements.

The media delivery module of the systems of the present invention can be configured to package the entertainment programming based on a user's settings and to check whether the media player contains a previously installed programming package.

In yet another embodiment, the media delivery module may be configured to delete the previously installed programming package prior to installing a new programming package. The media player may also collect usage data of the programming package for sending to the server. The usage data may comprise data such as a number of times a song or program is played, a number of times an advertisement is played, how long the packaged programming is in the media device, a number of times a song or program is skipped or fast forwarded, etc.

In yet another embodiment, the media delivery module may be configured to encrypt the programming package prior to transmitting the package to the media player, which can be a portable electronic device such as, for example, a portable music player or a portable game console.

In one embodiment of the present invention, methods for media delivery are provided. The method may comprise the steps of: packaging a programming material with an advertisement as a programming package; delivering the programming package to an authorized media player; and collecting usage data on the programming package from the authorized media player.

In another embodiment of the present invention, a computer program product for delivering entertainment programming is provided. In one embodiment, the computer program product comprises a computer useable medium having computer readable program code functions embedded in the medium for causing a computer to deliver entertainment programming. Such code may comprise: a first computer readable program code that causes the computer to package entertainment programming material with an advertisement as a programming package; a second computer readable program code that causes the computer to deliver the programming package to an authorized media player; and a third computer readable program code that causes the computer to collect usage data on the programming package from the authorized media player.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example environment with which the present invention can be implemented.

FIG. 2 illustrates an example user interface that can be implemented by a system and method according to one embodiment of the present invention.

FIG. 3 illustrates an example user interface for downloading a according to one embodiment of the present invention.

FIG. 4 illustrates an example user interface according to one embodiment of the present invention.

FIG. 5 illustrates an example user interface according to one embodiment of the present invention.

FIG. 6 illustrates an example user interface that displays music genres according to one embodiment of the present invention.

FIG. 7 illustrates an example user interface that displays various television genres according to one embodiment of the present invention.

FIG. 8 illustrates an example user interface according to one embodiment of the present invention.

FIG. 9 is a flowchart representing the daily synchronization process using a method or system of the present invention, according to one embodiment.

FIG. 10 illustrates a chart showing the benefits of the present invention.

FIG. 11 illustrates an example computer system in which the present invention can be implemented.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

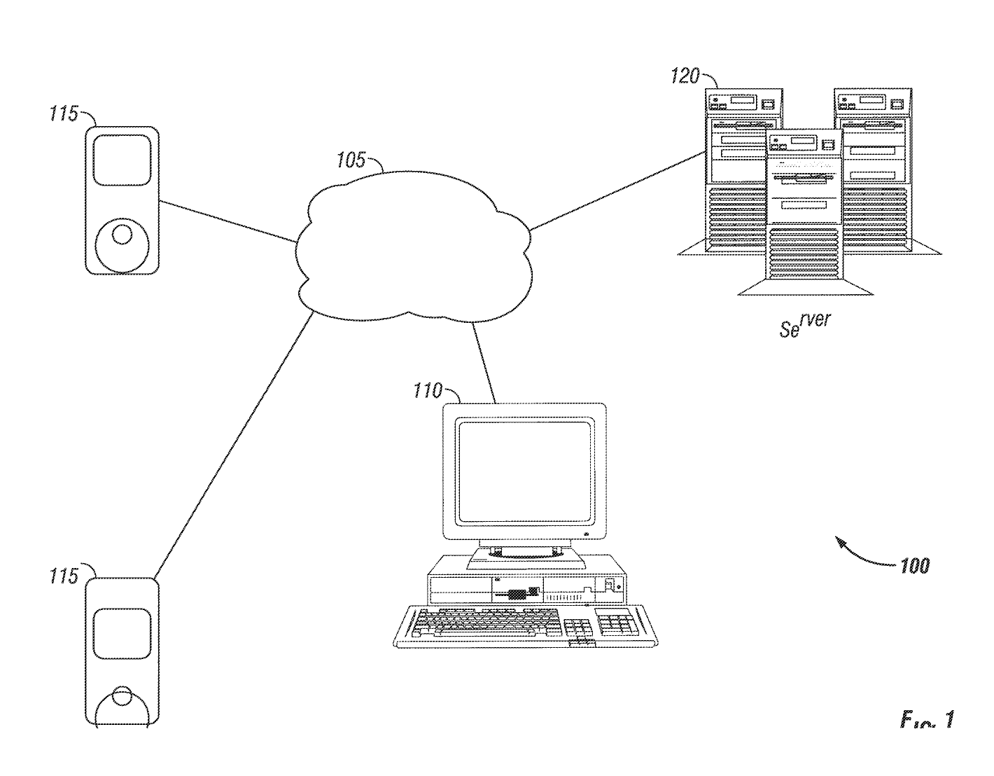

The methods and systems of the present invention provide digital entertainment programming packaged together with advertisement for use on subscriber's electronic media device. Before describing the invention in detail, it is useful to describe an example environment with which the invention can be implemented. One such example environment is shown in FIG. 1.

FIG. 1 illustrates an environment 100 with which the systems and methods of the present invention can be implemented according to one or more embodiments of the present invention. Referring now to FIG. 1, environment 100 includes a network 105, a computer 110, a media player or device 115, and a server 120. Network 105 can be the internet, a local area network (LAN), a wide area network (WAN), the plain old telephone system (POTS), wireless network or any other suitable network. Computer 110 is configured to communicate with network 105 using various communication interfaces such as, for example, WiFi, 802.11a/b/g/n, HomeRF, or other suitable communication protocols. Similarly, media device 115 can be configured to communicate with network 105 or computer 110 using various communication protocols such as, for example, Bluetooth, 802.11b/g, infrared, USB interface, or other suitable communication protocols. Using network 105 as a communication medium, computer 110 or media device 115 can communicate with server 120. Server 120 can be configured to provide on-demand, scheduled, or continuously streamed media content or entertainment programming to computer 110 or to media device 115 directly.

Media device or electronic media device 115 can be any device that can store and/or play media such as a personal computer or laptop and may be a mobile or portable device such as, for example, a portable music player, portable game console, or other portable entertainment device. In environment 100, a subscriber may access server 120 through a user interface such as a website. Using the website, the subscriber may download the current package to computer 110 or directly to media device 115. Server 120 can be configured to use a proprietary software to validate the subscriber's key. The software can also be configured to delete a previously installed programming package and to install a new programming package on the subscriber's media device 115 or computer 110, or to add a new programming package to a previously installed package, or to add or delete portions of each (for example, to update all or part of the previously installed programming package).

Server 120 may include a media delivery module (not shown) that is configured to deliver media (entertainment) programming or content to a remote device such as computer 110 and media device 115 at a predetermined interval or schedule. This may be done automatically or by request from the subscriber. In this wavy subscriber is able to chance the media programming available on media device 115 or computer 110 on a daily basis without having to buy each portion of media content or program, e.g., each song, individually. Server 120 may include a management module that tracks royalties and pay the royalties for each portion of media content or program, e.g., each song or program. In one embodiment, the media delivery module can be configured to attach or associate advertisements with or to a media content or program. In this way, a method for creating revenue associated with the delivery of the subject media content or program is implemented and, in one embodiment of the method, royalties for the media delivered can be paid out using advertising fees and/or subscription fees. The subscriber can choose each portion of media content or program, e.g., each song, in the package individually, providing a customized list. Alternatively, the subscriber can merely pick a genre and have a package automatically delivered to the electronic media device.

In one embodiment, all software and programming are stored at server 120. Server 120 can be a collection of servers located at a single site or can be servers at a plurality of locations.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

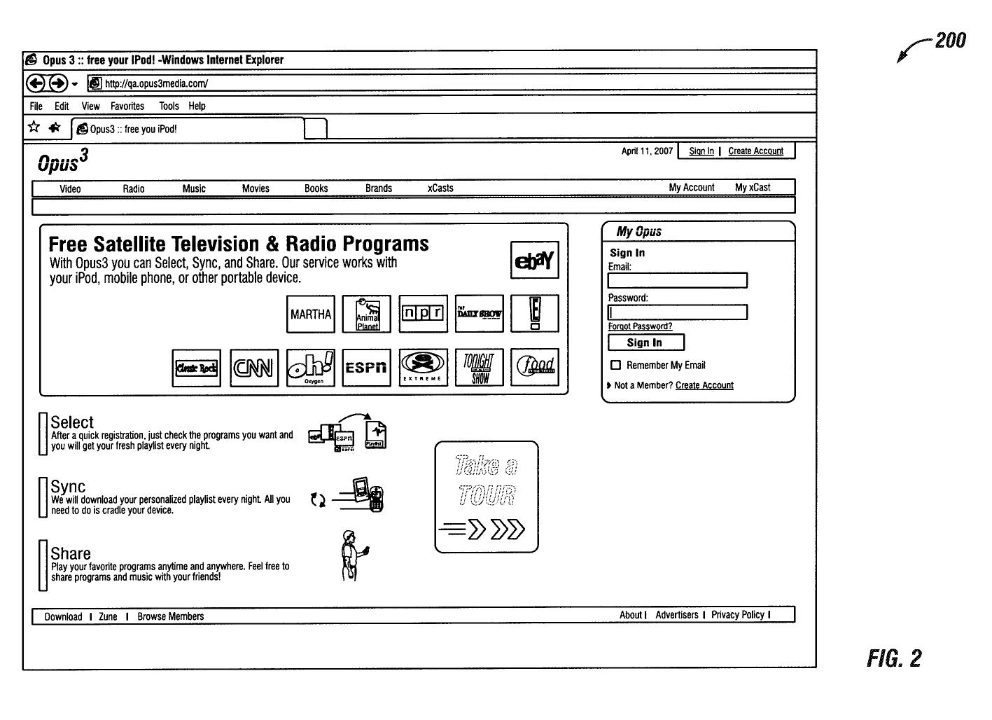

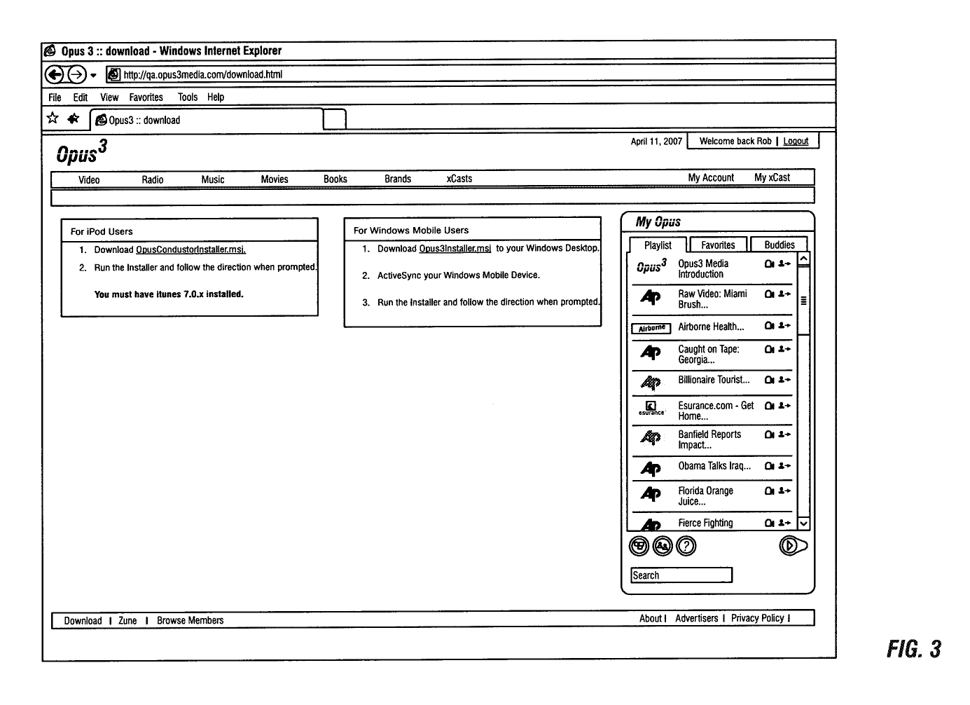

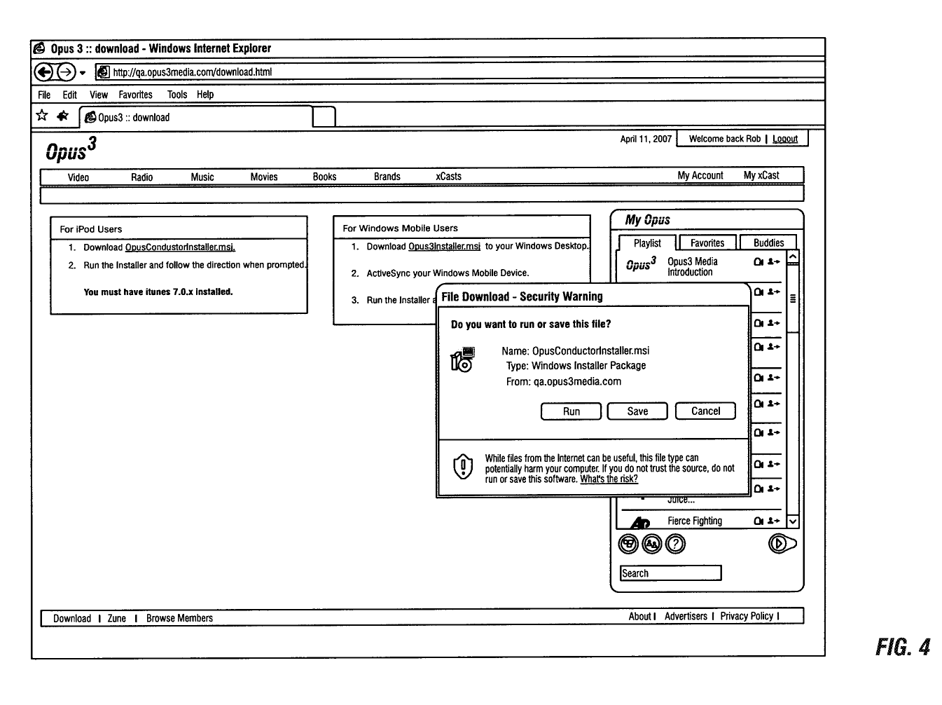

FIG. 2 shows an example website layout 200 that allows users to register with the service according to one embodiment of the present invention. Referring now to FIG. 2, layout 200 provides a user interface where the user provides certain identifying information, such as a user name and/or their e-mail address and a password. Other information, such as address and billing information, as well as demographic or other information may be requested and provided as well. Once this information is provided and in the case of a user or subscriber log on verified, the user gains access to the site. The user is then instructed, in one embodiment, to download a small helper application (“helper”) which is downloaded to the user's computer. In one embodiment, the media delivery module described above is integrated into the helper application. FIGS. 3-4 illustrate exemplary screen shots for the helper application downloading process. In the case of iPod iTunes users, iTunes, in a specific embodiment, must already be installed and then the user installs the helper. In the case of Windows Mobile Device users, they may first synch their electronic media device and then run the installer. In one embodiment, the helper uses a normal windows installer (for Microsoft applications) and in a specific embodiment requires minimal inputs from the user. See FIG. 4.

In one embodiment, the helper is the liaison between the system and the user's electronic media device via the users data handling program (i.e., iTunes or Windows Media Player). When the user synchs his electronic media device, the helper or the media delivery module, in one embodiment, may automatically remove the previous program and adds the current program. The helper may also limit use of the package to that user's electronic media device, thus preventing unauthorized duplication of the programming contained herein. The helper may also prevent users from fast-forwarding through advertisements in the case of advertisement-supported subscriptions. See FIG. 3 and FIG. 4.

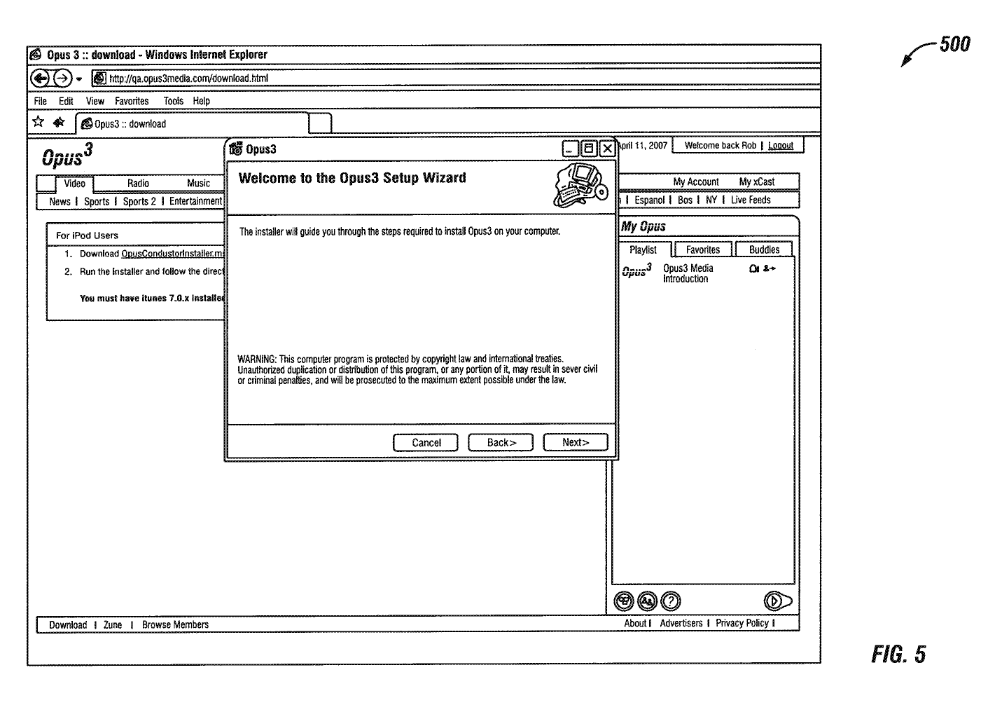

FIG. 5 illustrates the entertainment media portal 500 according to one embodiment of the present invention. Referencing now to FIG. 5, portal 500 may include the functions and features of a service provider website to allow the user to select a variety of programming from music, video, news, or other media program such as, for example, podcasts. Portal 500 can be installed on the user's local computer or could be configured as web application such as a Flash application. In one embodiment, portal 500 can be configured to allow the user to choose from a wide variety of music and video that are conveniently separated into genres or other categories or collections.

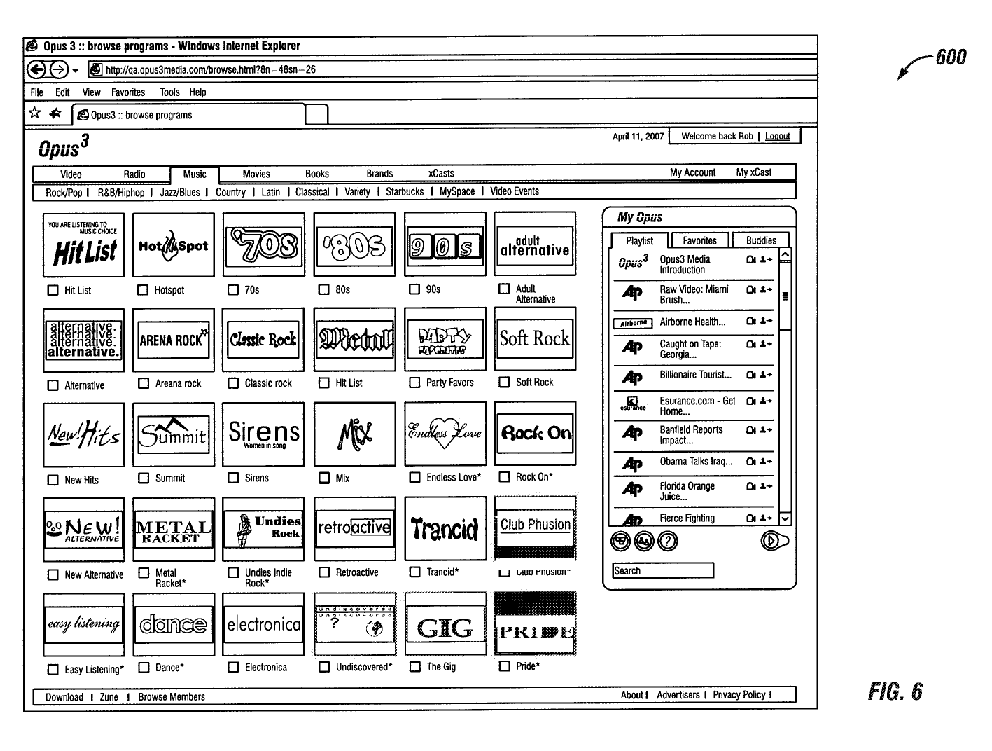

FIG. 6 illustrates an exemplary screenshot of portal 500 according to one embodiment of the present invention. Referring now to FIG. 6, portal 500 can be configured to display various entertainment choices such as, for example, various music genres or other categories or collections. From portal 500, the user may also select from a wide variety of television and vide programming including news, talk, entertainment, information, education, and sports. In one embodiment, portal 500 is configured to allow the users to create their own personal programming material such as a homemade video and upload the homemade programming to their media device 115.

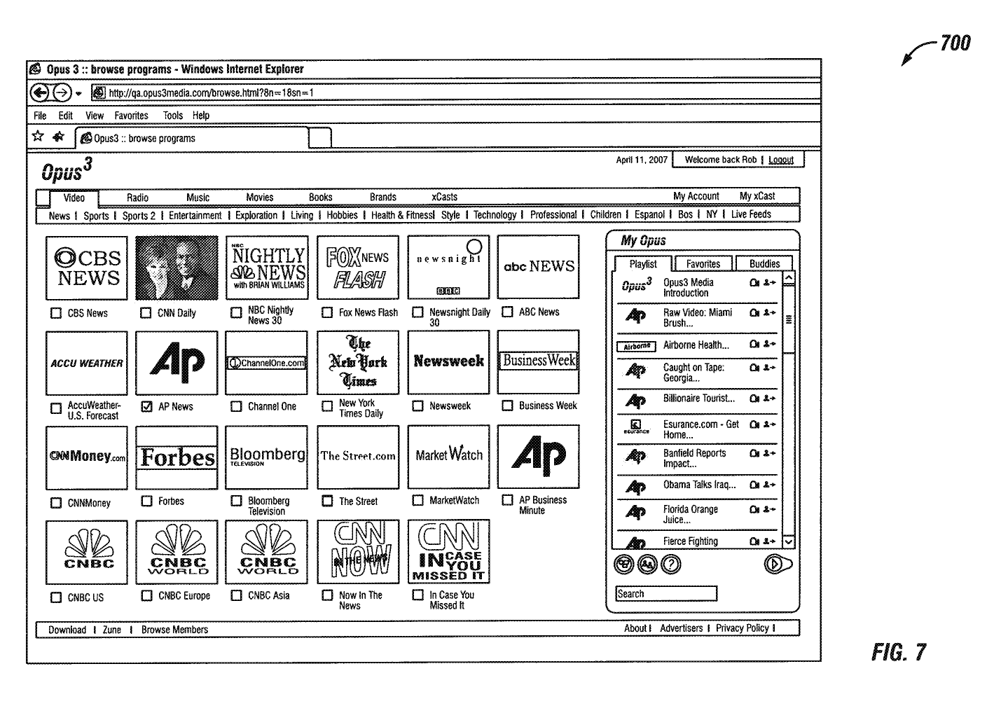

FIG. 7 is another exemplary screen shot of media portal 500 according to one embodiment of the present invention. Referring now to FIG. 7, portal 500 allows the user chose the type of packaged programming to be delivered to media device 115 or computer 110. The packaged programming can be music or various video programs such as, but not limited to, news or shows from specific television networks. In addition to being able to create programs and podcasts for their personal use, users can also share their programming with other users of the system through portal 500, such as is currently done with portals MySpace and YouTube. Users are able to designate other users of the system as “friends.” See FIG. 7. Once designated, portal 500 allows the users to share programs, playlists, and other information and make recommendations to friends provided the programming is within the friend's subscription rights. Although not described, portal 500 can be incorporated into the helper application or the media delivery module, all of which can also exist as a single application or multiple applications.

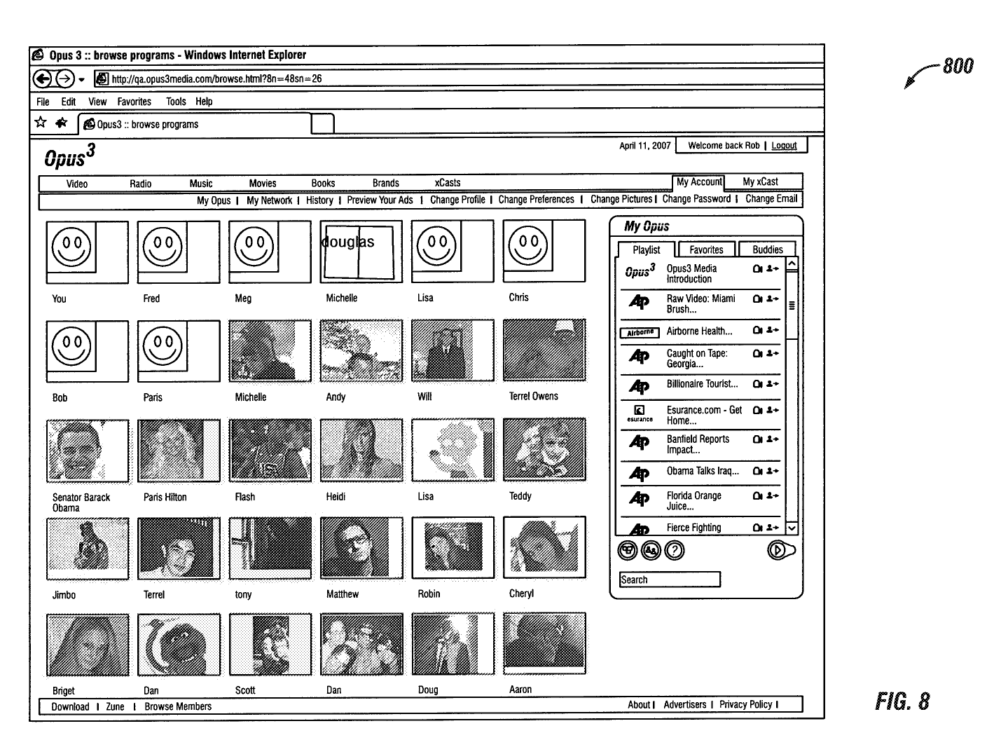

Referencing to FIG. 8, in yet another embodiment, the helper may provides a second important function for the success of the system. As mentioned above, when the user synchronizes his electronic media device, the helper program, in one embodiment, removes the previous program and uploads the current program to the user's electronic media device. However, during this process the helper may also collect usage statistics from the user's electronic media device. In one embodiment, the helper or the media delivery module can be configured to collect data such as, for example, the number of times the program has been played since uploaded, the number of times a particular advertisement has been played, whether certain songs have been skipped or fast forwarded, how long the program has been on the user's electronic media device, etc.

In another embodiment, this information is then uploaded to server 120, for example, when the user logs on to download the next program. This information can then be used in several ways. The usage statistics regarding how many times a particular song or program was played may be used to determine what royalties are due a copyright holder. These fees may negotiated in advance by the owner of the system. These royalties may be paid on a per play basis, as in the radio industry, or may be paid on a per-program basis. In the second case, users can replay songs as many times as they like without increasing royalty costs for the system.

The usage statistics are also used to bill advertisers. Again, as in radio, advertisers may be billed on a per play basis. In other words, if a user plays the program three times before they upload a new program, and an ad is played three times as a result, the advertiser is billed 3 times his per-play rate. Alternatively, advertisers may arrange to have a per program basis for their ads, or any other applicable basis or payment scheme or schedule. In one embodiment, the advertiser may pay a higher rate for this service on a per program basis, operating on the assumption that users will listen to programs more than once, thus lowering his effective per play rate.

Finally, advertiser may choose to buy large blocks of advertising and receive a “wholesale” rate. For instance, the terms may be to have their ads to be included in every program for a certain length of time, for example, a week, month, year or for multiple weeks, months or years. This allows the system to generate a large block of income up front, and allows the advertiser to reach a larger audience at a lower per play rate. Alternatively, the advertiser may choose to pre-pay for its ads to be included in, for example, 1500 user programs, but only users that download “Adult Alternative” music as part of their program. This allows for, e.g., a lower per play rate and/or targeted advertising.

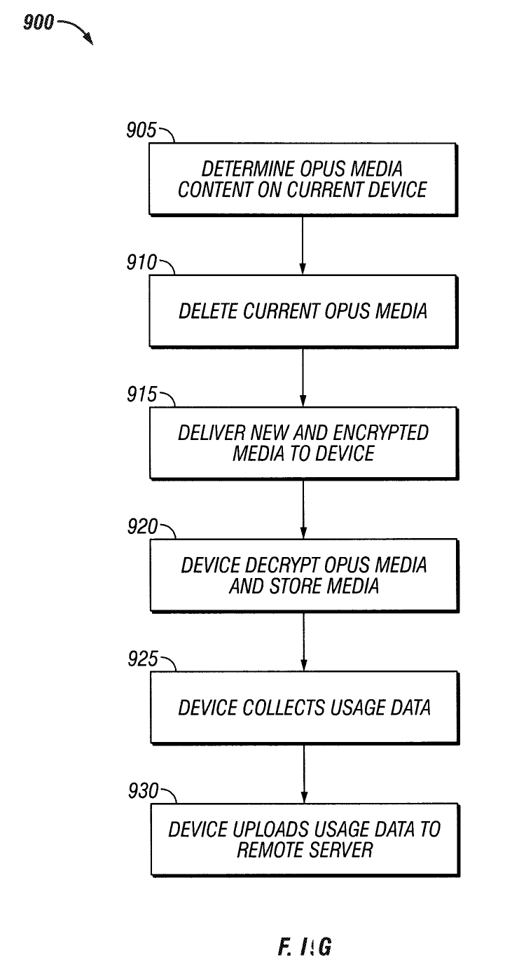

FIG. 9 illustrates an exemplary media delivery process 900 according to one embodiment of the present invention. Each of the helper application, the media delivery module, and/or the portal 500 can be implemented to execute media delivery process 900. Referring now to FIG. 9, process 900 starts at step 905 where the current content of media device 115 or computer 110 is determined. The current content (also referred to as Opus™ media) is the packaged content previously delivered to computer 100 or device 115 by the helper application or the media delivery module. As previously mentioned, an Opus™ media may include music, video, information, education or news programming packaged along with one or more advertisements embedded therein. For example, a media file can be prepared or packaged by server 115 to include all ten songs from the Top 10 Billboard® chart with one or more advertisements between each song. Thus, the packaged programming can include 10 songs and at least one advertisement. When the packaged programming is receive by a portable media player such as media player 115, the media player can be configured to play one or more of the advertisements between each song, every other song, or at a predetermined interval, or random interval. As mentioned, the content of the Opus™ media can be configured based on a user's settings or based on other metrics or settings, such as popularity charts like the American Top 40 or Billboard® charts. In one embodiment, in step 910, if an Opus™ media exists, it is deleted from the device.

In step 915, once the previous Opus™ media is deleted, a new Opus™ media programming is downloaded to the user's device, such as media player 115 or computer 110. Server 115 may deliver the Opus™ media in encrypted or unencrypted format. In one embodiment, as shown in step 915, the Opus™ media is encrypted prior to transmitting the Opus™ media to the user's device. In step 920, the media device or computer decrypts the encrypted Opus™ media for authentication and storage. In one embodiment, all or part of the previous media and/or the new media is added or deleted. For example, there may be only certain updates available at the time of downloading (for example, with news or weather information). Also, in a specific embodiment, the user may want to selectively keep all or a portion of the previous media instead of it being replaced with new media.

In step 925, the usage data of the Opus™ media is collected. The data collected can be a variety of data, including but not limited to the number times a song, program or advertisement is played, the frequency in which the media player or computer synchs with server 120 for new content, etc. In step 930, the collected data may be sent to server 120 for analysis ad payment processing. For example, if a particular song ‘a’ was listened to 20 times, then the software on the server 120 can calculate and appropriately pay the royalty and, an a specific embodiment, charge the advertisement sponsor accordingly and/or pay any royalty.

Process 900 gives the subscribers, for example, a more convenient outlet from which to obtain programming content, e.g., licensed music. For instance, after obtaining a subscription, no additional burden is placed on subscribers, they merely synch their electronic media device as they always have. Further, the system may automatically adjust to subscribers changing preferences based on usage statistics, or other metrics, for example the type of content and/or the amount of content may correlate to the price and/or type of subscription. Additionally the system may allow users to have a different programming on their electronic media device on a daily or other periodic, ad hoc or constant basis without having to take the manual steps of assessing, locating and/or purchasing their own programming content, e.g., music.

The benefit to the service provider is also a factor in the systems and methods of the present invention. While some investment of time and capital is involved, once in place, the system may function essentially automatically. Some of the primary aspects to be maintained are the programming itself and outside sales to advertisers. In one embodiment, the system automatically collects usage data from all subscriber's electronic media devices. This data can be used for any applicable purpose, for example, to better attend to subscribers' changing tastes and to bill advertisers. Indeed, in one embodiment, the systems of the present invention may automatically bill advertisers, hence lowering billing and accounting costs for the service provider.

Finally, the entertainment industry benefits by having an alternative source of royalty income. The system provides means for monetizing a variety of users. Heavy music consumers may be given a cost-effective outlet for large amounts of new content programming daily, or on any appropriate period or basis, or on an ad hoc basis. Users that might otherwise forgo buying any programming (e.g., music) may be incentivized or monetized with, for example, a lower subscription rate, smaller daily programs, less features, more advertising, or a combination thereof.

In one embodiment, portal 500 or the helper application can be configured to deliver content, and specifically, for example, music to computer 110 or media device 115. Additionally, because subscribers may choose to receive new programming everyday, or on another periodic or continuous basis, they may be more likely to find and ultimately purchase content, and specifically, for example, music that they prefer or like. Further, the system automatically provides usage statistics on either a per play or per program basis. This insures, for example, accurate royalty payments to the copyright owners. And because the system is convenient, it may also reduce the incidence of music pirated over the internet.

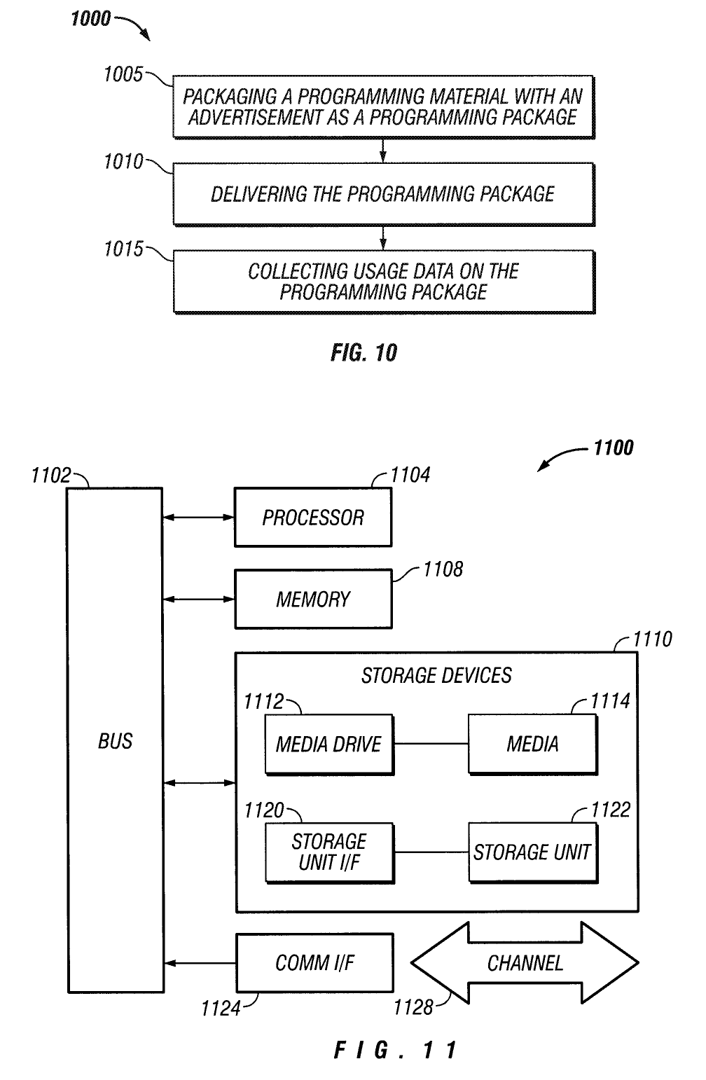

FIG. 10 illustrates a media delivery process 1000 according to one embodiment of the present invention. Process 1000 starts at step 1005 where a programming material is packaged with an advertisement material. A programming material can be a music program, a video program, or any other type of entertainment program. The package having the programming material and the advertisement material can be referred to as the Opus™ media or the programming package. In step 1010, the programming package is delivered to the users device. In one embodiment, the user's device is a portable media device such as, for example, a portable media player or a portable game console. In a step 1015, usage data of the programming package is collected and, in one embodiment, later analyzed. The usage data may include data such as, but not limited to, a number of times a media program is played, a number of times an advertisement is played, which program is skipped and how many times, which program is forwarded and how many times, etc.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

As used herein, the term module might describe a given unit of functionality that can be performed in accordance with one or more embodiments of the present invention. As used herein, a module might be implemented utilizing any form of hardware, so ware, or a combination thereof. For example, one or more processors, controllers. ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the ad after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example—computing module 1100. After reading this description, it will become apparent to a person skilled in the relevant art how to implement the invention using other computing modules or architectures.

Referring now to FIG. 11, computing module 1100 may represent, for example, computing or processing capabilities found within desktop, laptop and notebook computers; hand-held computing devices (PDA's, smart phones, cell phones, palmtops etc.); mainframes, electronic media players, supercomputers, workstations or servers; or any other type of special-purpose or general-purpose computing devices as may be desirable or appropriate for a given application or environment. Computing module 1100 might also represent computing capabilities embedded within or otherwise available to a given device. For example, a computing module might be found in other electronic devices such as, for example, digital cameras, electronic media players, navigation systems, cellular telephones, portable computing devices, modems, routers, WAPs, and other electronic devices that might include some form of processing capability.

Computing module 1100 might include, for example, one or more processors or processing devices, such as a processor 1104. Processor 1104 might be implemented using a general-purpose or special-purpose processing engine such as, for example, a microprocessor, controller, or other control logic. In the example illustrated in FIG. 11, processor 1104 is connected to a bus 1102 or other communication medium to facilitate interaction with other components of computing module 1100.

Computing module 1100 milt also include one or more memory modules, referred to as main memory 1108. For example, preferably random access memory (RAM) or other dynamic memory, might be used for storing information and instructions to be executed by processor 1104. Main memory 1108 may also be used for storing temporary variables or other intermediate information during execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage mechanism 1110, which might include for example, a media drive 1112 and a storage unit interface 1120. The media drive 1112 might include a drive or other mechanism to support fixed or removable storage media 1114. For example, a hard disk drive, a floppy disk drive, a flash drive, a solid state memory device, a magnetic tape drive, an optical disk drive, a CD or DVD drive (R or RW), or other removable or fixed media drive. Accordingly, storage media 1114, might include, for example, a hard disk, a floppy disk, magnetic tape, cartridge, optical disk, a CD or DVD, solid state memory, or other fixed or removable medium that is read by, written to or accessed by media drive 1112. As these examples illustrate, the storage media 1114 can include a computer usable storage medium having stored therein particular computer software or data.

In alternative embodiments, information storage mechanism 1110 might include other similar instrumentalities for allowing computer programs or other instructions or data to be loaded into computing module 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory module) and memory slot, a PCMCIA slot and card, and other fixed or removable storage units 1122 and interfaces 1120 that allow software and data to be transferred from the storage unit 1122 to computing module 1100.

Computing module 1100 might also include a communications interface 1124. Communications interface 1124 may be used to allow software and data to be transferred between computing module 1100 and external devices. Examples of communications interface 1124 might include a modem or softmodem, a network interface (such as an Ethernet, network interface card, WiMedia, 802.XX or other interface), a communications port (such as for example, a USB port, IR port. RS232 port Bluetooth interface, or other port), or other communications interface. Software and data transferred via communications interface 1124 might typically be carried on signals, which can be electronic, electromagnetic, optical or other signals capable of being exchanged by a given communications interface 1124. These signals may be provided to communications interface 1124 via a channel 1128. This channel 1128 might carry signals and might be implemented using a wired or wireless medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1108, storage unit 1120, media 1114, and signals on channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “anchor” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system on a remote server comprising:
a server having a plurality of entertainment and advertisement programs;
a media delivery module configured to package a programming package having embedded advertisements, wherein the programming package contains entertainment programs from the server; and
a media player in communication with the delivery module configured to receive and play the entertainment programming package with embedded advertisements.

2. The system of claim 1, wherein the media delivery module is configured to package the entertainment programming based on a user's setting.

3. The system of claim 1, wherein the media delivery module is configured to check whether the media player contains a previously installed programming package.

4. The system of claim 3, wherein the media delivery module is configured to delete the previously installed programming package prior to installing a new programming package.

5. The system of claim 1, wherein the media player is configured to collect usage data of the programming package for sending to the server.

6. The system of claim 5, wherein the usage data is selected from one or more of the group consisting of a number of times a song is played, a number of times an advertisement is played, and how long the package programming is in the media device.

7. The system of claim 1, wherein the media delivery module encrypts the programming package prior to transmitting the package to the media player.

8. The system of claim 1, wherein the media player comprises a portable electronic device.

9. The system of claim 7, where in the media player is configured to decrypt and store the programming package.

10. A method comprising the steps of:
packaging a programming material with an advertisement as a programming package;
delivering the programming package to a media player; and
collecting usage data on the programming package from the media player.

11. The method of claim 10, further comprising deleting any previously delivered programming package in the media player prior to delivering the programming package.

12. The method of claim 10, further comprising:
encrypting the programming package prior to delivering the programming package.

13. The method of claim 10, further comprising authorizing the media player prior to delivering the programming package.

14. The method of claim 13, wherein the media player is configured with a key to authenticate itself with a server.

15. The method of claim 10, wherein the programming material is selected from one or more media from the group consisting of music, video, and news programming.

16. The method of claim 10, wherein the media player is a portable media device.

17. The method of claim 10, wherein the media player is configured to collect the usage data.

18. The method of claim 10, wherein usage data is selected from one or more of the group consisting of a number of times a song is played, a number of times an advertisement is played, and how long the packaged programming is in the media device.

19. The method of claim 10, wherein the media player is an authorized media player.

20. A method comprising the steps of:
erasing any current programs from a subscriber's electronic media player connected to the subscriber's computer;
downloading encrypted data from a remote server; applying the subscriber's key;
exporting a program into the subscriber's computer's data management program;
approving the subscriber's key with the data management program;
accepting the new program by the data management program; and
uploading the new program to subscribers electronic media player with the data management program.

21. A method comprising the steps of:
synchronizing a subscriber's electronic media player with the subscriber's data management program;
downloading usage statistics from the electronic media player to the data management program;
transferring the usage statistics from the data management system to the proprietary software; and
uploading subscriber usage statistics to supplier's server from the proprietary software.

22. A method comprising the steps of:
uploading usage statistics from proprietary software located on subscribers' computer;
compiling the usage statistics from all subscribers for a given billing period; and
billing advertisers based on the compiled usage statistics.

23. A method comprising the steps of:
uploading usage statistics from proprietary software located on subscribers' computer;
compiling the usage statistics from all subscribers for a given billing period; and
paying royalties to the copyright owners based on the usage statistics.

24. A computer program product comprising a computer useable medium having computer readable program code functions embedded in said medium for causing a computer deliver a media programming comprising:
a first computer readable program code that causes the computer to package a programming material with an advertisement as a programming package;
a second computer readable program code that causes the computer to deliver the programming package to an authorized media player; and
a third computer readable program code that causes the computer to collect usage data on the programming package from the authorized media player.

25. The computer program product of claim 24, further comprising a fourth computer readable program code that causes the computer to delete any previously delivered programming package in the media player prior to delivering the programming package.

26. The computer program product of claim 24, further comprising a fourth computer readable program code that causes the computer to encrypt the programming package prior to delivering the programming package.

27. The computer program product of claim 24, further comprising a fourth computer readable program code that causes the computer to authenticate the media player prior to delivering the programming package.

28. The computer program product of claim 24, wherein the media player is configured with a key to authenticate itself with a server.

29. The computer program product of claim 24, wherein the programming material is selected from one or more media of the group consisting t of music, video, and news programming.

30. The computer program product of claim 24, wherein the media player is configured to collect the usage data.

31. The computer program product of claim 24, wherein usage data is selected from one or more of the group consisting of a number of times a song is played, a number of times an advertisement is played, and how long the packaged programming is in the media device.
